(19) United States
(12) Patent Application Publication
(10) Pub. No.: US 2025/0117330 A1
(43) Pub. Date: Apr. 10, 2025

(54) ADDRESS REMAPPING OF DISCARDED SURFACES

(71) Applicant: ADVANCED MICRO DEVICES, INC., Santa Clara, CA (US)

(72) Inventors: Dana Schaa, Santa Clara, CA (US); Mark Fowler, Boxborough, MA (US); Saurabh Sharma, Santa Clara, CA (US); Noah Fredriks, Boxborough, MA (US)

(21) Appl. No.: 18/617,092

(22) Filed: Mar. 26, 2024

Related U.S. Application Data
(60) Provisional application No. 63/542,625, filed on Oct. 5, 2023.

(51) Int. Cl. G06F 12/0815

(52) U.S. Cl. CPC G06F 12/0815

(57) ABSTRACT

As part of rendering a scene including at least one graphics object in a display space, the display space is divided into a plurality of tiles. A determination is made that contents of at least two of the plurality of tiles are no longer used after a current render pass. A write back memory address associated with a second tile is changed to match a write back memory address associated with a first tile. As a result, data is overwritten on a same physical page.

### BACKGROUND

As part of rendering a scene using tiled rendering, processing systems divide a screen space of the scene into a plurality of tiles, which are often sized such that a memory footprint of a tile fits within an on-chip cache. Each tile is then assigned to one or more rasterization engines of a graphics processing unit (GPU). In some cases, the one or more rasterization engines then process graphics objects or surfaces of respective tiles serially or in parallel. In some cases, data corresponding to the graphics objects or surfaces is large enough that evictions of the data occur during processing of the data (e.g., due to architectural limitations or having a cache capacity smaller than a size of a working set) or during subsequent processing corresponding to other tiles. Accordingly, data is periodically written to memory as part of an eviction process. Further, it is difficult for the rasterization engines to determine whether the data is no longer used. In some cases, processing systems waste an undesirable amount of resources (e.g., memory space, power, network bandwidth, etc.) writing the data from a cache to memory after data will no longer be used.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a processing system that implements address remapping of discarded surfaces in accordance with some implementations.

FIG. 2 is a block diagram of a first example of breaking a scene into tiles as part of address remapping of discarded surfaces in accordance with some implementations.

FIG. 3 is a block diagram of an example of remapping addresses as part of address remapping of discarded surfaces in accordance with some implementations.

FIG. 4 is a block diagram showing a second example of breaking a scene into tiles as part of address remapping of discarded surfaces in accordance with some implementations.

FIG. 5 is a flow diagram of a method of address remapping of discarded surfaces in accordance with some implementations.

### DETAILED DESCRIPTION

In some cases, surfaces contain intermediate results within a scene to be rendered, and a determination is made that one or more surfaces are to be discarded (e.g., because the one or more surfaces are identified as being no longer used after a current render pass). In some implementations, the determination is based on receiving an indication from an application programming interface (API). In other implementations, the determination is based on receiving an indication from a driver (e.g., based on the driver analyzing a data dependency graph or based on the driver receiving an application hint via an API). During a tiled rendering process, a scene that includes graphics objects in a displace space is divided into multiple tiles. Surfaces that are to be discarded are similarly divided into at least two tiles (e.g., previously divided or divided as part of the current render pass) that are no longer used after a current render pass.

After tile data is identified as being no longer used, in some systems, removing that tile data is difficult. For example, in some cases, architectural limitations prevent discarding tile data or a system having a cache capacity smaller than a working set leads to evictions before discarding occurs. In some systems, a scrubber is used to discard cache lines, however such solutions have undesirably high mechanical complexity.

To reduce rendering overhead, described below are techniques where, in response to the determination that the tile data is no longer used, a write back location (e.g., a physical page address) corresponding to one or more cache entries storing a second set of tile data (e.g., a virtual page) is changed to match a write back location corresponding to one or more cache entries storing a first set of tile data. As a result, the first and second sets of tile data are all written to a same set of physical pages. In some cases, one set of tile data overwrites another set of tile data. Accordingly, an amount of physical memory used by the writeback of the first and second sets of tile data is halved. In some implementations, write traffic corresponding to one of the first and second sets of tile data is also eliminated. In some implementations, write back locations of more than two tiles (e.g., 4 tiles, 16 tiles, or 5000 tiles) are changed to match. As a result, the amount of physical memory consumed by the tiles collectively, and, in some cases, the corresponding write traffic, is similarly reduced.

This disclosure will discuss tiles in terms of two-dimensional tiles for clarity and ease of explanation. However, this disclosure is similarly applied to systems utilizing tiles having different numbers of dimensions (e.g., one-dimensional tiles, three-dimensional tiles, four-dimensional tiles, or N-dimensional tiles). As a result, systems utilizing tiles having different numbers of dimensions are also contemplated.

The techniques described herein are, in different implementations, employed using any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). For ease of illustration, reference is made herein to example systems and methods in which certain processing circuits are employed. However, it will be understood that the systems and techniques described herein apply equally to the use of other types of parallel processors unless otherwise noted.

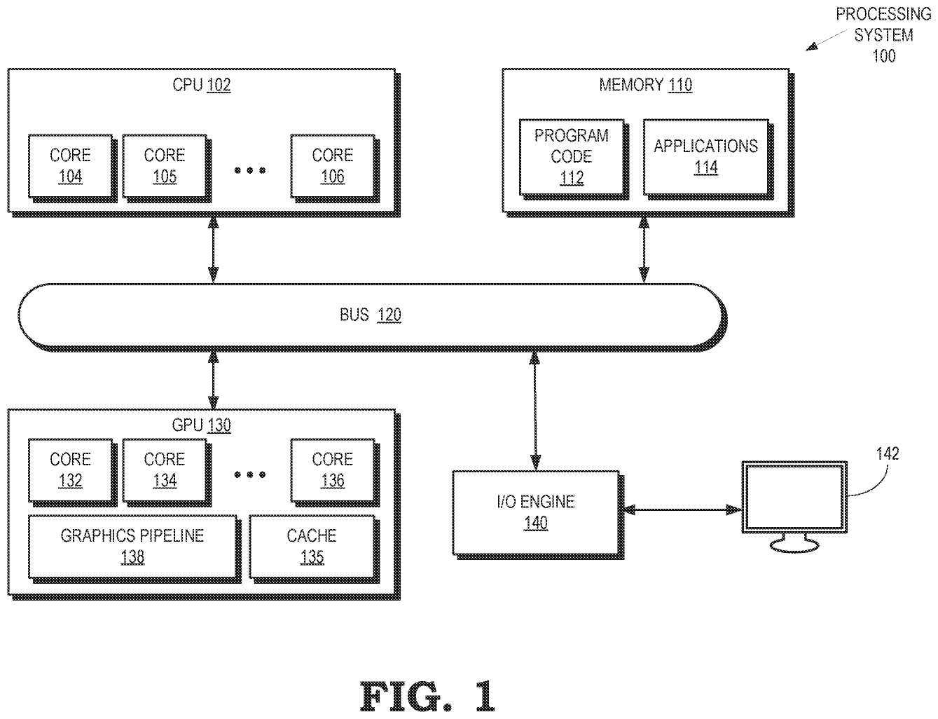

Referring now to FIG. 1, a processing system 100 that implements address remapping of discarded surfaces is presented, in accordance with some implementations. Processing system 100 includes or has access to memory 110 or other storage component implemented using a non-transitory computer-readable medium such as a dynamic random-access memory (DRAM). However, in some implementations, memory 110 is implemented using other types of memory including, for example, static random-access memory (SRAM), nonvolatile RAM, and the like. According to some implementations, memory 110 includes an external memory implemented external to the processing units implemented in the processing system 100. Processing system 100 also includes bus 120 to support communication between entities implemented in processing system 100, such as memory 110. Some implementations of processing system 100 include other buses, bridges, switches, routers, and the like, which are not shown in FIG. 1 in the interest of clarity.

GPU 130 includes cores 132, 134, and 136 that are each able to execute one or more instructions separately or in parallel. In some implementations, cores 132, 134, and 136 each include one or more single instruction, multiple data (SIMD) units that perform the same operation on different data sets to produce one or more results. Though in the example implementation illustrated in FIG. 1, three processor cores (132, 134, and 136) are presented, the number of processor cores implemented in GPU 130 is a matter of design choice. Cores 132, 134, and 136 receive data to process via graphics pipeline 138. In some cases, as part of execution, data corresponding to one or more of cores 132, 134, and 136 is stored at cache 135. In some implementations, cache 135 is part of one or more of cores 132, 134, and 136. In other implementations, some or all of cache 135 is separate from cores 132, 134, and 136. In some cases, when a corresponding portion or all of cache 135 is determined to be full, excess data is sent to other memory space (e.g., the excess data is copied to the other memory space as part of removing the excess data from cache 135). As discussed further below, in some implementations, this other memory space is part of GPU 130. In other implementations, this other memory space is part of memory 110. GPU 130 renders a set of rendered frames each representing respective scenes within a screen space (e.g., the space in which a scene is displayed) according to one or more applications 114 for presentation on a display 142. As an example, GPU 130 renders graphics objects (e.g., one or more surfaces) of a display space of a scene so as to produce pixel values representing a rendered frame. GPU 130 then provides the rendered frame (e.g., pixel values) to display 142. These pixel values, for example, include color values (e.g., YUV color values or RGB color values), depth values (e.g., z-values), or both. After receiving the rendered frame, display 142 uses the pixel values of the rendered frame to display the scene including the rendered graphics objects.

In various implementations, processing system 100 also includes CPU 102 that is connected to the bus 120 and therefore communicates with GPU 130 and memory 110 via bus 120. CPU 102 includes a plurality of processor cores 104, 105, and 106 that execute instructions concurrently or in parallel. Though in the example implementation illustrated in FIG. 1, three processor cores (104, 105, and 106) are presented, the number of processor cores implemented in CPU 102 is a matter of design choice. Processor cores 104, 105, and 106 execute instructions such as program code 112 for one or more applications 114 (e.g., graphics applications, compute applications, machine-learning applications) stored in memory 110, and CPU 102 stores information in the memory 110 such as the results of the executed instructions. CPU 102 is also able to initiate graphics processing by issuing draw calls to the GPU 130.

In some implementations, processing system 100 includes input/output (I/O) engine 140 that includes circuitry to handle input or output operations associated with display 142, as well as other elements of processing system 100 such as keyboards, mice, printers, external disks, and the like. I/O engine 140 is coupled to bus 120 so that I/O engine 140 communicates with memory 110, GPU 130, and CPU 102. In some implementations, CPU 102 issues one or more draw calls or other commands to GPU 130 which cause rendering of objects within a screen space. In response to the commands, GPU 130 divides the screen space into a plurality of tiles and schedules one or more of cores 132, 134, and 136, respectively, to process one or more of the tiles each. In response to receiving an indication that data of at least two tiles will no longer be used, a write back location within cache 135 corresponding to one of the tiles is changed to match a write back location corresponding to another one of the tiles.

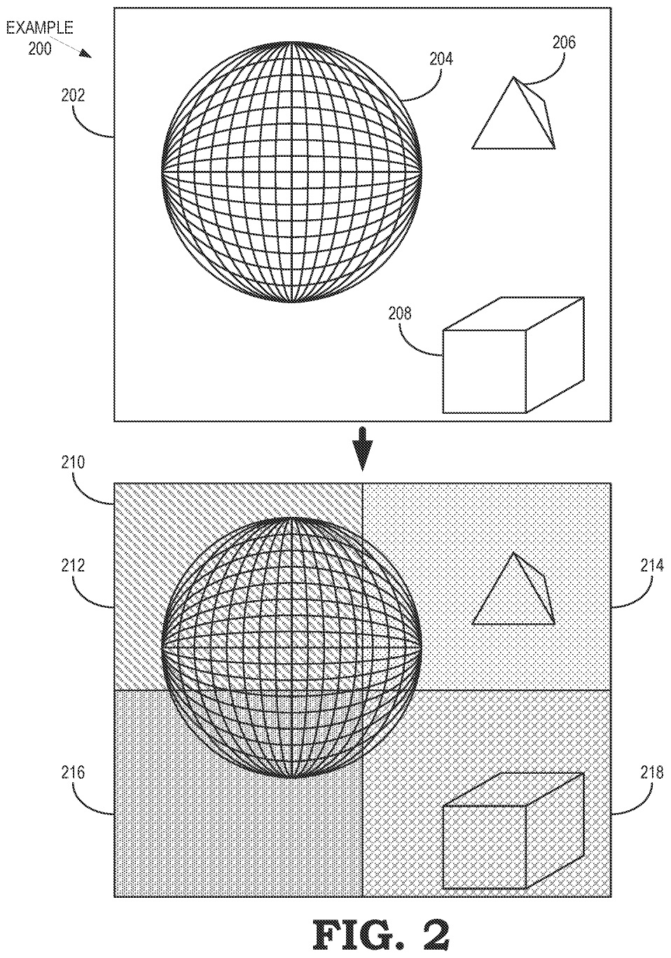

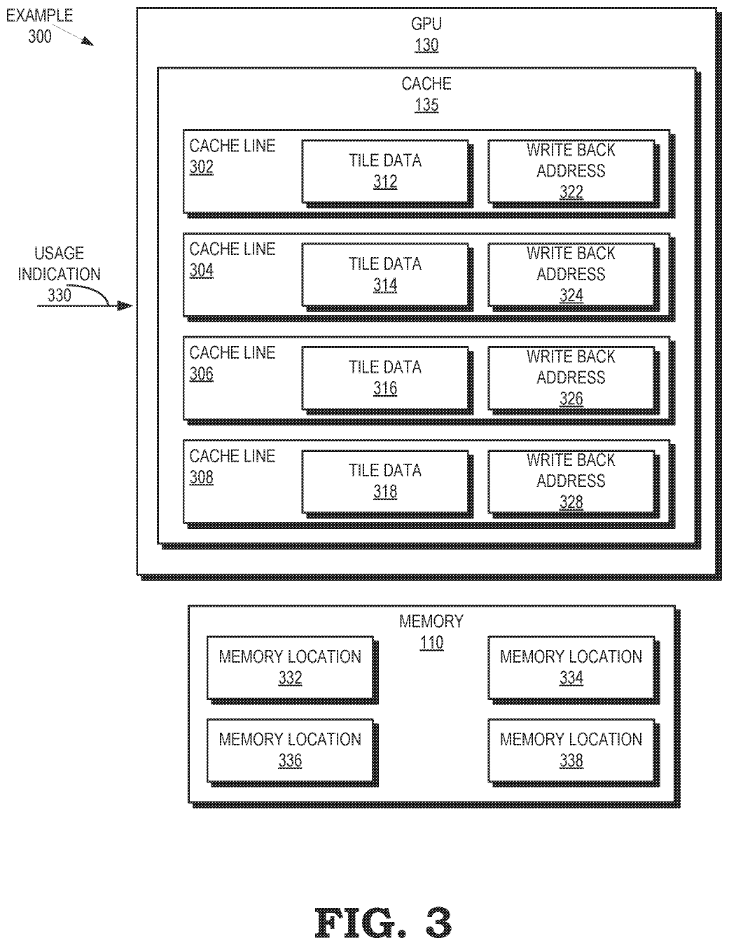

FIGS. 2 and 3 collectively depict a process of breaking a scene into tiles and then performing address remapping of corresponding to tiles determined to be no longer used. Four tiles, four corresponding cache lines, four corresponding memory locations, and three graphics objects are used for ease of explanation. However, different numbers of tiles, cache lines, memory locations, and graphics objects are also contemplated. Further, in some cases, the examples do not represent all of a scene or device (e.g., a scene includes more than four tiles even if only four are discussed or a cache includes more than four cache lines even if only four are discussed or illustrated).

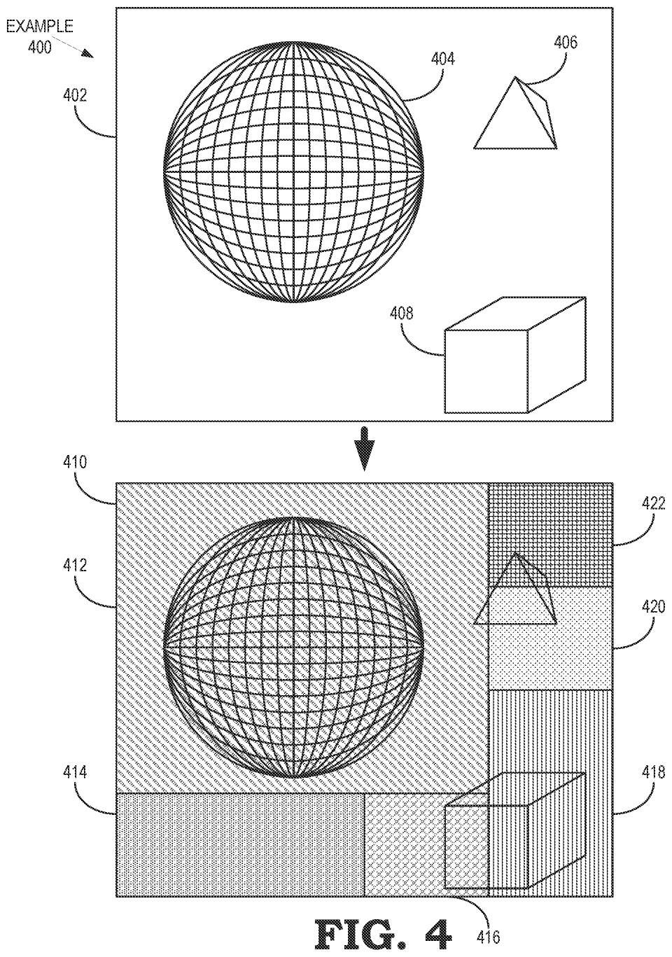

FIG. 2 is a block diagram depicting an example 200 of breaking a scene into a group of tiles, corresponding data of which is later discarded via address remapping. Example 200 depicts a scene, which includes display space 202. Display space 202 includes graphics objects 204, 206, and 208. Display space 202 is divided into a plurality of tiles, resulting in divided display space 210. Divided display space 210 includes tiles 212, 214, 216, and 218. In example 200, some graphics objects, such as graphics object 206, are fully included within a single tile (tile 214). Other graphics objects, such as graphics object 204, are divided between multiple tiles (tiles 212-218). As a result, the processing of tile 214 includes processing surfaces of graphics objects 204 and 206. As further discussed below with reference to FIG. 4, in some cases, some tiles do not include any graphics objects.

FIG. 3 is a block diagram depicting an example 300 of remapping write back addresses in response to determining that contents of at least two tiles are no longer used. Example 300 depicts GPU 130, cache 135, and memory 110 of FIG. 1. Cache 135 includes cache lines 302, 304, 306, and 308. Cache line 302 stores tile data 312 and write back address 322. Cache line 304 stores tile data 314 and write back address 324. Cache line 306 stores tile data 316 and write back address 326. Cache line 308 stores tile data 318 and write back address 328. Memory 110 includes memory locations 332, 334, 336, and 338. In other implementations, different numbers of devices are used. For example, in other implementations, cache 135 includes sixteen cache lines or one hundred twenty-eight cache lines. In other implementations, other arrangements of devices are used. For example, in some implementations, memory 110 is part of GPU 130.

In example 300, each of cache lines 302-308 stores tile data corresponding to a respective tile. Accordingly, tile data 312 corresponds to tile 212 of FIG. 2, tile data 314 corresponds to tile 214, tile data 316 corresponds to tile 216, and tile data 318 corresponds to tile 218. In some implementations, tile data corresponds to only a portion of a tile. In other words, tile size is not limited based on a size of cache 135. In some implementations, sizes of tiles are determined based on a size of cache 135 (e.g., tile sizes are determined to be a multiple of a size of cache 135). Write back addresses 322-328 indicate physical memory addresses used to store the tile data. Write back address 322 points to memory location 332, write back address 324 points to memory location 334, write back address 326 points to memory location 336, and write back address 328 points to memory location 338. In example 300, each of memory locations 332-338 are located on a different page of memory.

In some cases, tile data (e.g., tile data 314) is evicted from cache 135 and then returned to cache 135 at a later time (e.g., to a same cache line or to another cache line). As part of the eviction process, the evicted tile data is written to the location indicated by the corresponding write back address (e.g., memory location 334). As a result, it can be difficult to determine whether evicted tile data is being evicted for a last time. However, tile data which is evicted for a last time no longer needs to be preserved, which means that it is desirable to discard some or all of the tile data.

In example 300, usage indication 330 is received at GPU 130 and indicates that tile data of at least two tiles is no longer used. As a result, write back addresses of all but one of the indicated tiles are changed to match a write back address of the remaining indicated tile. For example, usage indication 330 indicates that tile data 314, 316, and 318 is no longer used. Write back addresses 324 and 328 are changed to point to memory location 336. As a result, a write back operation of tile data 314-318 writes all of the tile data to memory location 336, overwriting the two of tile data 314-318 (e.g., tile data 316 is written first, tile data 314 overwrites tile data 316, and then tile data 318 overwrites tile data 314). Accordingly, an amount of space in memory 110 used by tile data 314-318 is reduced, as compared to a system where the write back addresses are not changed. Further, in some implementations, writing is simpler or faster because all of the tile data is written to a same physical page. Additionally, in some implementations, less network bandwidth (e.g., bandwidth of BUS 120 of FIG. 1) is used because tile data 314-318 is accumulated at GPU 130 and only the tile data for a single tile (e.g., a last tile to have its tile data written) is copied to memory 110 as part of evicting the tile data from cache 135. Further, in some cases, modifying write back addresses is lower complexity and faster, as compared to scrubbing cache lines to discard tile data.

In different implementations, remapping write back addresses is accomplished in different ways. For example, in some implementations, page tables of graphics objects are updated to map a respective specific region corresponding to each graphics object of each tile (e.g., a full graphics object or a portion of a graphics object) to an initial region. In some implementations, each region of a graphics object is addressed by a single virtual to physical mapping (e.g., a large page), and each mapping points to the same physical address. In other implementations, texel coordinates corresponding to each tile are offset to remap each tile's region. As further discussed below with reference to FIG. 4, in other implementations, partially resident textures are utilized.

In various implementations, usage indication 330 is generated at one of several sources. In some implementations, usage indication 330 is received from an API (e.g., from a programmer or user), which tells GPU 130 which tiles are no longer used. In other implementations, usage indication 330 comes from a driver or other piece of software or firmware executed at GPU 130 or at another processor (e.g., CPU 102). In some implementations, the driver determines that the tiles are no longer used based on an application hint via an API. In other implementations, the driver determines that the tiles are no longer used by analyzing a data dependency graph of a tile or all graphics objects within a tile, looking at dispatch and draw instructions as boundary conditions.

FIG. 4 is a block diagram depicting an example 400 of breaking a scene into a group of tiles, corresponding data of which is later discarded via address remapping. Example 400 depicts a scene, which includes display space 402. Display space 402 includes graphics objects 404, 406, and 408. Display space 402 is divided into a plurality of tiles, resulting in divided display space 410. Divided display space 410 includes tiles 412, 414, 416, 418, 420, and 422. Unlike example 200 of FIG. 2, at least one of tiles 412-422 has a different size from at least one other tile of tiles 412-422 in divided display space 410, and example 300 utilizes partially resident textures. Therefore, each of tiles 412-422 is sized such that each tile is a multiple of a same page size. In example 400, some graphics objects, such as graphics object 404, are fully included within a single tile (tile 412). Other graphics objects, such as graphics object 406, is divided between multiple tiles (tiles 412, 420, and 422). As a result, the processing of tile 412 includes processing surfaces of graphics objects 404 and 406. In some cases, some tiles, such as tile 414, do not include any graphics objects.

Tile data corresponding to tiles 412-422 is processed in a manner similar to the manner described above with regard to FIG. 3. Further, in response to a determination that tile data is no longer used, a write back address corresponding to the tile data is modified as described above. As a result, physical memory space is saved, a write back process is performed more quickly, bandwidth is saved, power is saved, or any combination thereof, as compared to a system where write back addresses are not modified. Further, in some cases, modifying write back addresses is lower complexity and faster, as compared to scrubbing cache lines to discard tile data.

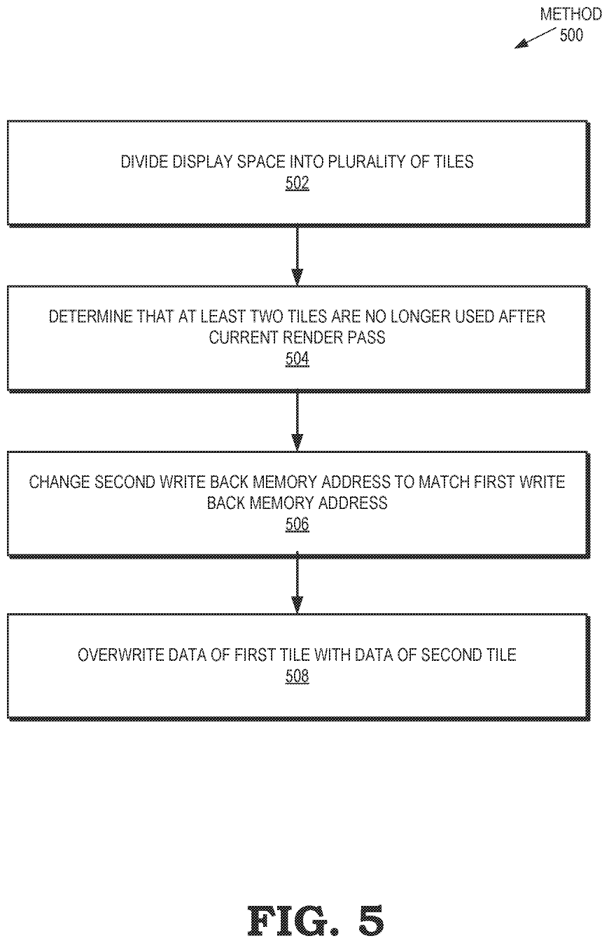

FIG. 5 is a flow diagram illustrating a method 500 of address remapping of discarded surfaces in accordance with some implementations. In some implementations, method 500 is initiated by one or more processors in response to one or more instructions stored by a computer readable storage medium.

At block 502, a display space is divided into a plurality of tiles. For example, display space 202 of FIG. 2 is divided into tiles 212-218. At block 504, a determination is made that at least two tiles are no longer used after a current render pass. For example, usage indication 330 of FIG. 3 is received, indicating that tiles 212 and 214 are no longer used.

At block 506, a second write back memory address is changed to match a first write back memory address. For example, write back address 322 is changed to match write back address 324. At block 508, data of a first tile is overwritten with data of a second tile. For example, tile data 314, corresponding to tile 214, is overwritten with tile data 312, corresponding to tile 212. Accordingly, a method of address remapping of discarded surfaces is depicted.

In some implementations, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), or Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some implementations, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some implementations, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that cause any benefit, advantage, or solution to occur or become more pronounced are not to be construed as a critical, required, or essential feature of any or all the claims. Moreover, the particular implementations disclosed above are illustrative only, as the disclosed subject matter could be modified and practiced in different but equivalent manners apparent to those skilled in the art having the benefit of the teachings herein. No limitations are intended to the details of construction or design shown herein, other than as described in the claims below. It is therefore evident that the particular implementations disclosed above could be altered or modified and all such variations are considered within the scope of the disclosed subject matter. Accordingly, the protection sought herein is as set forth in the claims below.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations. “Circuitry” and “circuit” are used throughout this disclosure interchangeably.

Within this disclosure, in some cases, different entities (which are variously referred to as “components,” “units,” “devices,” “circuitry,” etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

What is claimed is:

1. A method comprising:
rendering a scene comprising one or more graphics objects in a display space that is divided into a plurality of tiles, comprising:
determining that contents of at least two tiles of the plurality of tiles are no longer used after a current render pass; and
changing a second write back memory address associated with a second tile of the at least two tiles to match a first write back memory address associated with a first tile of the at least two tiles.

2. The method of claim 1, further comprising:
subsequent to performing the current render pass, overwriting data of the first tile with data of the second tile at the first write back memory address.

3. The method of claim 1, wherein determining that the contents of the at least two tiles are no longer used comprises receiving an indication from an application programming interface (API) that the at least two tiles are no longer used.

4. The method of claim 1, wherein determining that the contents of the at least two tiles are no longer used comprises receiving an indication from a driver that the contents of the at least two tiles are no longer used.

5. The method of claim 4, wherein receiving the indication from the driver comprises the driver analyzing a data dependency graph corresponding to the display space.

6. The method of claim 4, wherein receiving the indication from the driver comprises the driver receiving the indication via an application programming interface (API) from an application that generates data of the scene.

7. The method of claim 1, wherein at least two of the plurality of tiles have different sizes.

8. The method of claim 1, further comprising:
dividing the display space into the plurality of tiles, comprising determining a tile size based on a cache size of a cache that is to store at least some of the plurality of tiles after they are rendered.

9. The method of claim 8, wherein the cache comprises a memory location addressed by the first write back memory address.

10. A processor, comprising:
a graphics core associated with a plurality of tiles of a display space and configured to:
determine that contents of at least two tiles of the plurality of tiles are no longer used after a current render pass; and
change a second write back address associated with a second tile of the at least two tiles to match a first write back address associated with a first tile of the at least two tiles.

11. The processor of claim 10, wherein determining that the contents of the at least two tiles are no longer used comprises receiving an indication from an application programming interface (API) that the at least two tiles are no longer used.

12. The processor of claim 10, wherein determining that the contents of the at least two tiles are no longer used comprises receiving an indication from a driver that the contents of the at least two tiles are no longer used.

13. The processor of claim 12, wherein receiving the indication from the driver comprises the driver analyzing a data dependency graph corresponding to the display space.

14. The processor of claim 12, wherein receiving the indication from the driver comprises the driver receiving the indication via an application programming interface (API) from an application that generates data of the display space.

15. The processor of claim 10, wherein at least two of the plurality of tiles have different sizes.

16. A processing system, comprising:
a bus;
a first processing circuit configured to issue a plurality of commands via the bus; and
a second processing circuit configured to receive the plurality of commands from the first processing circuit, and comprising:
a cache;
a graphics core associated with a plurality of tiles of a display space and configured to:
determine that contents of at least two tiles of the plurality of tiles are no longer used after a current render pass; and
change a second write back memory address of the cache associated with a second tile of the at least two tiles to match a first write back memory address of the cache associated with a first tile of the at least two tiles.

17. The processing system of claim 16, wherein determining that the contents of the at least two tiles are no longer used comprises receiving an indication from an application programming interface (API) that the at least two tiles are no longer used.

18. The processing system of claim 16, wherein determining that the contents of the at least two tiles are no longer used comprises receiving an indication from a driver that the contents of the at least two tiles are no longer used.

19. The processing system of claim 16, further comprising:
a memory configured to store data, wherein the second processing circuit is configured to copy data from the cache to the memory as part of removing that data from the cache.

20. The processing system of claim 19, wherein changing the second write back memory address causes the second processing circuit to write either write back data associated with the first tile or write back data associated with the second tile, but not both, from the cache to the memory.
